(19) United States
(12) Patent Application Publication
(10) Pub. No.: US 2018/0082307 A1
(43) Pub. Date: Mar. 22, 2018

(54) SELECTION OF PRE-ARRANGED ASSISTANCE FROM AN ELECTRONIC QUALIFICATION TRANSACTION

(71) Applicant: Experian Health, Inc., Franklin, TN (US)

(72) Inventors: Michael Peter Ochs, Franklin, TN (US); Donavon R. Feenstra, Cane Ridge, TN (US); Jason Harrison Wallis, Spring Hill, TN (US); Richard W. Farmer, Nashville, TN (US); Steffi Silva, Nashville, TN (US)

(73) Assignee: Experian Health, Inc., Franklin, TN (US)

(21) Appl. No.: 15/475,706

(22) Filed: Mar. 31, 2017

Related U.S. Application Data
(60) Provisional application No. 62/396,638, filed on Sep. 19, 2016.

(51) Int. Cl. G06Q 30/00

(52) U.S. Cl. CPC G06Q 30/016

(57) ABSTRACT

Improvements in bandwidth usage, accuracy, and speed are provided when handling ambiguously coded data via a qualification request. Communicating parties, even when conforming to an industry-defined standard, may often include ambiguously coded values in their communications, complicating the communication between entities. To enable parties to use their own interpretations of the standards and receive desired results from the other parties using incompatible interpretations of the standards, synonymous codings are used to identify candidate options prior to transmission to the other party. The candidate options an analyzed according to various rules or courses to quickly and accurately identify a preferred match for a code, which is presented to a user. The user is enabled to update the code to match the other party's interpretation or override the determination to use the original or a different code. The communication is then handled according to the user's code selection.

### CROSS-REFERENCES TO RELATED APPLICATIONS

The present disclosure claims priority to U.S. Provisional Patent Application No. 62/396,638 filed on 19 Sep. 2016, the disclosure of which is hereby incorporated by reference in its entirety.

### BACKGROUND

Industry standards have been implemented for enabling providers (optionally via an intermediary system) to submit electronic inquiries to verify a consumer's qualifications for pre-arranged assistance with a specified assistance provider and to receive an electronic response comprising information about whether and to what extent the consumer is covered. Although there are standards for how these qualification transactions are to be constructed, the interpretation of those standards from assistance providers and service providers in terms of how to encode and the data can vary wildly, thus causing confusion in communications between parties and resulting in sub-optimal outcomes or requiring multiple communications between the parties to resolve the confusion.

### BRIEF SUMMARY

Selection of a “best” assistance option is provided. A qualification request, including a service type code, a pre-arranged assistance provider identifier, and a list of assistance types with an electronic qualification transaction is received by a qualification system. The request is processed to select a course applicable to the assistance type being requested. Service categories and assistance types are predefined and can be selected in any combination by the user. Courses may be created with one or more attributes such as client, trading partner, assistance provider, assistance provider type, service category, assistance type, etc. The “best” assistance type is then found by performing a waterfall analysis procedure on service type, coverage level, time period qualifier, and network indicator. The response comprising the best assistance amount is returned to the requestor.

The qualification system normalizes data, allowing complex integration with various client systems. The system uses a course-based process that allows the client to select assistance options from standard-based transactions, allowing for the selection of the client-preferred assistance options from a plurality of valid assistance options. By providing normalized data, fewer calls to the assistance provider organizations need to be made, reducing the use of network bandwidth and improving the speed at which consumers and clients are provided with accurate and optimized pre-arranged assistance plan details for a given service—regardless of how the different parties differ in codifying that service.

### BRIEF DESCRIPTION OF THE DRAWINGS

Further features, aspects, and advantages of the systems and methods represented by the examples described in the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 illustrates one aspect of the qualification system;

FIG. 2 is a high level flowchart of one example of a method for providing qualification determinations;

FIG. 3 is a block diagram of an architecture in which qualification determinations are provided;

FIG. 4 is a high level flowchart of one example of a method for providing qualification determinations; and

FIG. 5 is a block diagram illustrating example physical components of a computing device with which aspects of the system may be practiced.

### DETAILED DESCRIPTION

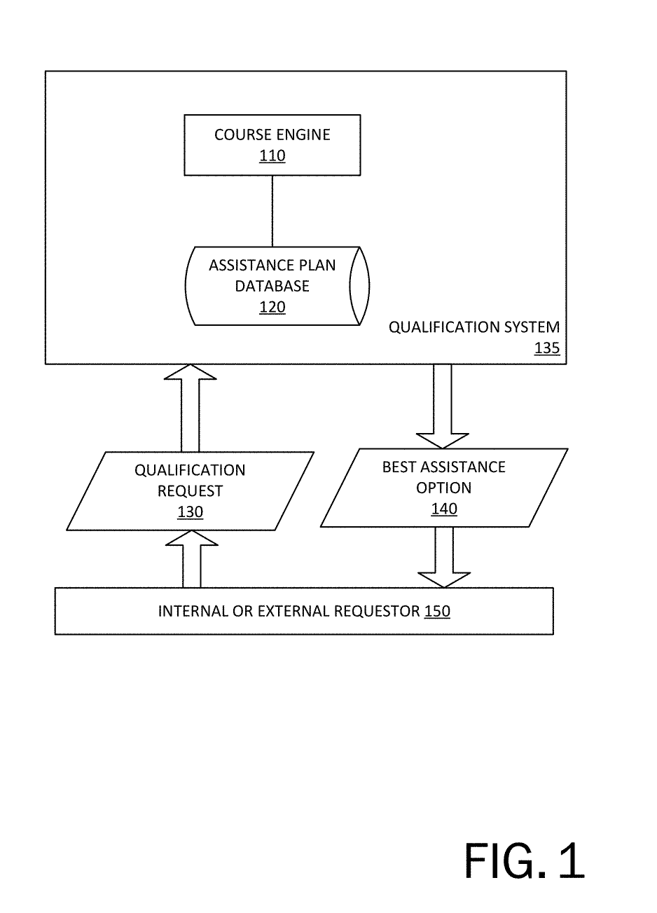

FIG. 1 illustrates one aspect of a qualification system 135. The system includes a course engine 110 and an assistance plan database 120. The course engine 110 includes course data defined by the client, including various attributes for a plurality of service categories and provider types, to find the best assistance option available for a given qualification request. The assistance plan database 120 comprises the various assistance options available from pre-arranged assistance providers based on the various different courses defined by the client. The qualification system 135 takes data from the qualification request 130, and parses them through the course engine 110 to find a best assistance option 140 from the assistance plan database 120 based on the courses defined by the client. In FIG. 1, it is further illustrated how a qualification request 130 is sent from an internal or external requestor 150 to the qualification system 135 to derive the best assistance option 140 as a result.

A qualification system 135, and methods of use thereof, are described herein and illustrated in the accompanying figures. The qualification system 135 includes functionality for providing the best assistance option from a plurality of assistance options in an electronic qualification transaction. The system is operable to configure courses (for a given pre-arranged assistance provider or the requestor) to determine the best assistance option for a consumer from the valid assistance options. If multiple results are returned for a potential service, the system selects the “best” assistance option based on the client's preferences.

The determination of which assistance option to select is performed internally by the qualification system 135, based on data from the requestor in a qualification request and data from assistance provider systems that have been pre-gathered. The requestor 150 may therefore submit one request to the qualification system 135 for multiple analyses of available assistance options will take place; reducing the amount of bandwidth used to determine a preferred option from the valid and available options for assistance. Additionally, due to the multiple analyses being handled at one time and location, an accurate response may be formatted faster than before for the client or consumer's review. Moreover, once an option has been selected by the client or consumer, the qualification system 135 may optionally update the transaction with the best option and forward the transaction to the pre-arranged assistance provider for further processing, without the requestor 150 needing to resend the entire transaction, further reducing the used of bandwidth.

Several examples given herein deal with messaging standards used in healthcare transactions, but the disclosure is not so limited. Transactions for pre-arranged assistance may be conducted in various industries, including, but not limited to: automotive, marine, architectural, construction, etc., which may each make use of various messaging standards. A messaging standard (e.g., HL7 and X12 for healthcare) often does not support new programs introduced in the industry (e.g., Accountable Care Organizations (ACO) and Managed Care Organizations (MCO)) for a long period of time after the new program has already affected the industry; it takes a long time for the standards to be updated to accommodate the newest programs. Therefore the entities wedge new types of information into existing codes set by the existing specification however they can, which introduces variation and confusion. For example, it is challenging to report ACO/MCO information with any consistency when the standards were set before these entity types existed.

In one example, in the case of a service type for “emergency services” provided by a medical service provider, there are service type codes that are attached to the pre-arranged assistance options that indicate whether the assistance applies to inpatient, hospital, vision, dental, and so forth. For example, an “emergency service” may be validly coded with an “86” in a HIPPA communication. Not all of the entities acting as pre-arranged assistance providers, however, use service type code “86” to describe emergency services; they may use a different one that is equally valid under the standard to refer to what the provider terms as “emergency services”. For example, of the 187 service type codings available under HIPPA, at least five can be reasonably used to reflect general emergency services, and several others may be more specific to the rendered services; different entities frequently use different service types to refer to the same services.

The qualification request 130 identifies: a product/service, provider type, and a list of service categories/assistance options/keys. Service categories and assistance options are predefined and can be selected in any combination by the client. Service categories define various service areas such as, in a healthcare context: CT/MRI Imaging, Emergency Services, Hospice, Hospital Inpatient, etc.

In one aspect, the qualification request 130 is matched against assistance options according to categories of: assistance type, coverage level, network level, and various key values. Assistance types consist of pre-service settlement amounts, additional pre-arranged assistance amounts, pre-assistance settlement amounts, etc., and are further defined by coverage level, network, and keys. To make the requesting process simpler, predefined groups of assistance options such as “In-Network Assistance” can also be requested. Coverage levels include individual and group levels, whereas network levels include in-network, out-of-network, and in-or-out-of-network levels. Key values include: Charge master codes, Current Procedural Terminology (CPT) codes, delivery models, place of service, plan codes, etc.

The qualification system 135 configures data received in the qualification request 130 from multiple (potentially inconsistent) entities into a consistent data model. In one aspect, the qualification system 135 is integrated into a response handler as a sub-process thereof. For example, a response handler takes a 271-transaction and builds an object model from the data contained in fields therein. The qualification system 135 attempts to remove all the differences in coding the data included in the 271-transaction. The response handler is thereby operable to normalize data fields related to demographics, plan names, group names, etc. When a call is made to the response handler, the response handler takes the 271-transaction and builds a consistent data model based on the data included in the 271-transaction, which in some aspects includes a qualification request 130. The qualification system 135 is request driven while the response hander is event driven; a 271-transaction is received and the event handler will process it to normalize the inputs.

The qualification system 135 is request driven with three parts to a request: a service category (which is a broad category of what the service entails); a specific assistance type that is requested, (e.g., a family level pre-assistance settlement amount within a network); and a key for locating a course set for choosing the best assistance option. The qualification system 135 is configured to return a single assistance value for a given service category/assistance type combination that is requested, instead of the several potential values that various entities may use. According to an aspect, when the qualification system 135 is in communication with the client (e.g., a medical/automotive/educational service provider) and the client sends a transaction, the client sends the request for the service category and the assistance along with that transaction to the qualification system 135 to format it according to the interpretation used by the eventual receiving entity (e.g., an insurance provider, a second educational institution).

The qualification system 135 provides a process that looks for the assistance option with a submitted service type code, and if it does not find assistance options under that code, then looks for assistance options under other related codes (e.g., for a secondary service type, a tertiary service type, etc.) until an assistance option is found. The client can still use the one initially-submitted code for “emergency services” that is considered “emergency services” in the larger world in its normal course of transactions. The qualification system 135 will deal with entities that code the service type differently, such that, for example, if entity A may codes a service differently from the requestor 150 or entities B through Z, and the qualification system 135 will ensure that transaction between the requestor 150 to entities A-Z are all handled optimally. The qualification system 135 cascades through the available pre-assistance settlements and entity responsibilities for the consumer and a given pre-arranged assistance provider and, based on what has been determined as the highest priority for the service type, cascades through the options until a match is found.

In another aspect where the selection of assistance options is based on a client request, sometimes there are multiple pre-assistance settlement amounts available. In one example, multiple pre-assistance settlement amounts are returned for the exact same service type code. In another example, two or more pre-assistance settlements are returned that have different service types. If there is more than one pre-assistance settlement option, the client may want the given pre-assistance settlement to be the option having the highest amount, the lowest amount, a highest percentile relative to the service, etc. The client therefore specifies various courses to return the assistance option with the highest amount, the lowest amount, or that is first found. These courses are stored in the course engine 110 and enable the qualification system 135 to cascade or “waterfall” through various options to arrive at the client's preferred option faster and more efficiently.

In another example, the client has the ability to override the selection of assistance options made by the qualification system 135. For example, it may have been determined by the qualification system 135 that “86” is the best service type code for emergency services, so by default it is offered up as the “best” when there are multiple assistance options available for that service, but clients can override that selection if they have a different opinion on what “best” entails. The qualification system 135 not only handles inconsistencies between pre-arranged assistance providers and requestors 150, but also allows clients to override the determined selection.

In one example, clients are enabled to use the qualification system 135 to find assistance options to provide estimates for consumers via a postback system. The qualification system 135 will find assistance options for a hypothetical service that the consumer desires an estimate for, and post those estimated amounts back to the client system. The actual requestor, making the request, is one of the clients, such as an internal request from a response handler or postback system.

In one use case, the qualification system 135 provides the assistance options based on the facility at which the service is performed. For example, to provide field-level assistance information, and put it back in the client's postback system during a consumer's visit so that the client has the assistance information on record for the consumer. The client may be very specific about the assistance desired, which is usually based on the facility. If, for example, the facility is an inpatient facility, when data are posted back, they comprise all of the inpatient data for the consumer, but not outpatient data. Therefore, the qualification system 135 has a configuration that provides the client with service level data that are requested when a response handler is called.

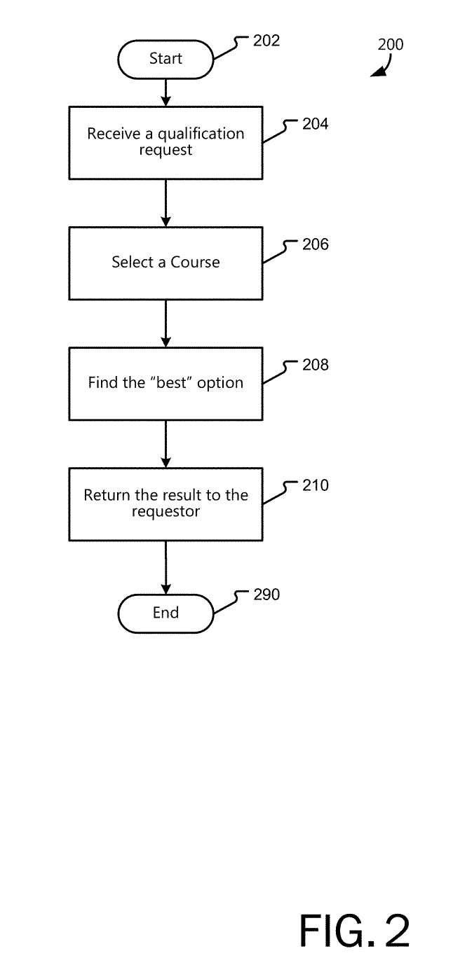

FIG. 2 is a high level flowchart of one example of a method 200 for providing qualification determinations. Method 200 starts at OPERATION 202, and proceeds to OPERATION 204, where a qualification request 130 is received. Receiving the qualification request 130 initiates a qualification determination process to enable the client to request the “best” assistance option for a service category/assistance available to a consumer. In some aspects, the qualification request 130 is transmitted with a 271-transaction or an assistance transaction to the qualification system 135.

The method 200 proceeds to OPERATION 206 where a course is selected. Courses are created by the client to describe what qualifies as the “best” assistance option for a particular situation. The courses define a hierarchy of assistance values, and in some aspects, courses are created with the following attributes: client name, trading partner name, pre-arranged assistance provider name, product/service name, client type, service category, assistance type, key values, etc. A course is selected based on the attributes provided by the client. The most specific course is selected with the order of priority being client, trading partner, and pre-arranged assistance provider. For example, a course defined for a specific client/pre-arranged assistance provider will be used before a course for specific trading partner/pre-arranged assistance provider, and so forth. Default courses are set up for all service categories and assistance types. Default courses do not have a client, trading partner, or pre-arranged assistance provider defined, and will be used as the course of last resort.

Once a request is made, the qualification system 135 finds a course to determine the specific assistance available to a consumer. For example, if a client (e.g., automotive repair service provider) makes a request to learn of the assistance available to a consumer (e.g., a vehicle owner), the request will identify various features related to the consumer and the pre-arranged assistance provider/plan available to the consumer. When selecting courses, keys values attached to the course are also examined. For example, a client, such as prescription drug event (PDE), may attach a charge master code, a CPT code, a revenue code, etc., to a course and when the client makes the request, the client passes code to define the course accordingly. If the client has defined an attribute specifically for a CPT code, for example, the course can be defined for taking into account that attribute. In another example, when a client, such as a PDE, defines a course, the client associates an attribute with the course that allows the course to be used if the service code is X. For example, if the client requests assistance using service code X, then the courses that the qualification system 135 will find will be the one that is associated with service code X as opposed to a course that is associated with service code Y.

In another aspect, while selecting a course, multiple keys values can be attached in a single qualification request 130. For example, the client can pass in a charge master code and a CPT code. In that case, one course that uses both of those keys may be used. If the request is for a charge master code X and a CPT code B, the qualification system 135 will search for a course that is associated with those two attributes, and if the qualification system 135 does not find such a course, it returns a message that a course could not be found. In another example, the qualification system 135 may also use the default course when a course matching key values cannot be found. When a default course is used, the qualification system 135 returns the assistance along with data regarding which course was used in identifying the assistance. The course data may be returned back to the internal or external requestor 150 in the form of a status update with a course identifier for the course that was used.

In various aspects, there is a different course set for each grouping of attributes. The courses that best apply to what is requested are selected in a hierarchical fashion to identify: a client-specific course; an assistance plan specific course; and a global course. Further, all of these service category codes can have a default course which can be defined as a global “best” approach so that clients can define and collect their own courses to override the global course if the clients have the need for a specially defined course set for a given facility, pre-arrange assistance provider, service type, etc.

The method 200 then proceeds to OPERATION 208 where a best assistance option is determined. There are four pieces of information through which the waterfall process passes to determine the best option. The first level is the service type codes, such as emergency services, air transportation, etc. The next level is coverage level code, for example, an individual or group level of pre-arranged assistance. The next level is a time period qualifier, for example, a pre-assistance settlement amount for the calendar year, a pre-assistance settlement amount related to a pre-service settlement amount, etc. The final level is the network indicator, which is the in-network, out-of-network, or in-or-out of network level. The qualification system 135 starts the search by looking for the first service type with the first coverage level code with the first time period qualifier with the first network indicator. If the qualification system 135 finds an assistance option that matches with the first set of values, the qualification system 135 returns the result as the “best” assistance option. If the qualification system 135 does not find a “best” assistance option under an in-network code, then the qualification system 135 looks for the out-of-network code using the same values for service type code, coverage level code, and time period qualifier. After all of the network indicators have been tried, the system uses next value for the time period qualifier and tries the values for network indicators again to “waterfall” through the list of values until the best assistance option is returned.

For example, a “waterfall search” may be performed on the following assistance attributes: service type (e.g., 86, 52, 51, 50, 30); a coverage level (e.g., IND, EMP), a time period qualifier (e.g., 27, 26, 7, 13, 6); and a network indicator (e.g., Y, W, blank, U, N) as defined under the standard used for the qualification request 130. For example, if the requested assistance type is a pre-assistance settlement, then the pre-assistance settlement amount (EB*C segments) in the 271-transaction are looped through until one is found with the most-desired set of attributes. The attributes are processed in a “waterfall” fashion, from most desirable to least. An example of waterfall processing using the above examples would try “86|IND|27|Y” first, then “86|IND|271W”, then “86|IND|27|blank”, etc., until an assistance option with the most-desired set of attributes is found or “30|EMP|6|N” is tried. As defined in the above waterfall layout, preference for attributes from best to worst indicate grouping “86|IND|27|Y” to be the best candidate, “86|IND|27|W” to be the second-best candidate, “30|EMP|6|U” to be the second-worst (or two-hundred-forty-ninth-best) candidate, and “30|EMP|6|N” to be the worst (or two-hundred-fiftieth-best) candidate.

As will be appreciated, different clients may set courses for which attributes (and the values thereof) are processed first in a waterfall and if any exceptions to the waterfall are to be implemented. For example, an exception may state that “86|IND|27|blank”, despite occurring third in the normal sequence, is to be checked at position n in the sequence or is to be omitted from analysis. Include/Exclude expressions can also be defined to include or exclude attribute combinations from the search based on other data contained in the 271-transaction such as messages, places of service, group ID's/names, plan type, and plan coverage description. For example, any assistance options with a message containing the word “Specialist” could be excluded or only assistance options with a place of service of X could be included.

In another example, if the client wants the course providing the highest amount of assistance, the qualification system 135 processes the entire list of attributes, rather than stopping at the first match in the waterfall, and finds all the assistance options that qualify, compares their values of assistance, and then returns the assistance option with the highest value. For example, as the qualification system 135 is looping through the waterfall process, and finds a best option, there can be additional attribute combinations or rules that make it not considered as a “best” option. Some examples of elements for which the client may establish additional rules for waterfall processing include but are not limited to: the message segments, the plan name, the plan description, group numbers, etc. For example, the client course may be to not ever use a “gold plan” assistance option or to include or exclude an option based on group number. The additional rules can be tweaked to tailor the returned “best” assistance options to meet the client's particular needs.

The method 200 proceeds to OPERATION 210, where a response is returned to the requestor 150 identifying the “best” assistance option. The response to a qualification request 130 is returned in its own node in the regular response handler response. This node contains status information and the data for each requested service category/assistance option. When an amount of the best assistance option is returned to the requestor, whether it is pre-service settlement, pre-assistance settlement, etc., it may be in the form of a natural language message that states, for example, “your predicted settlement amount is X” based on the course used to determine the best assistance option.

In another example, the process to return the assistance amount in response to a qualification request 130 may run a plurality of times for one request because there are numerous consumer obligations for the service, such as total settlement amount, a remaining pre-assistance settlement amount, a pre-service settlement amount, an assistance cap (e.g., lifetime, time period), a settlement cap (e.g., a maximum out of pocket), etc. Different individual assistance values are used in determining the consumer's responsibility, therefore, the qualification system 135 uses all those values to determine the correct amount of the consumer's responsibility at the time of service.

In a further example, when no course is found, the status may not have any course identifier displayed, thus indicating to the client user that no course was found. In that case, when the qualification request 130 results in a no course found scenario, the client can further research the situation and review the qualification request 130 and/or create a course to use in the future analyses to prevent the no course found scenario from reoccurring. In another example, if the course is found but there is no associated assistance option found, the data indicating that no assistance was found is returned to the requestor 150.

The method 200 ends at OPERATION 290.

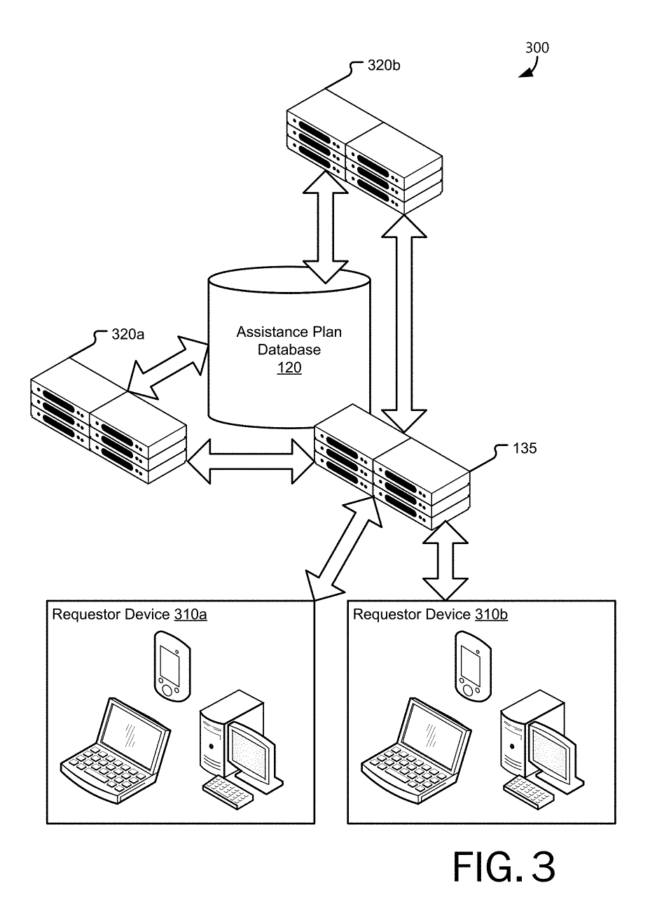

FIG. 3 is a block diagram of an architecture 300 in which qualification determinations are provided. As illustrated, a first requestor device 310a and a second requestor device 310b (generally, requestor devices 310) are in communication with the qualification system 135. The qualification system 135 maintains the assistance plan database 120, which is populated with data regarding assistance plans provided pre-arranged assistance providers. The systems of the pre-arranged assistance providers, first assistance provider system 320a and second assistance provider system 320b (generally, assistance provider system 320), are illustrated in communication with the assistance plan database 120 and the qualification system 135. Although two requestor devices 310 and two assistance provider systems 320 are shown in FIG. 3, one of ordinary skill in the art will appreciate that more or fewer requestor devices 310 and assistance provider systems 320 may comprise the architecture 300 in various aspects.

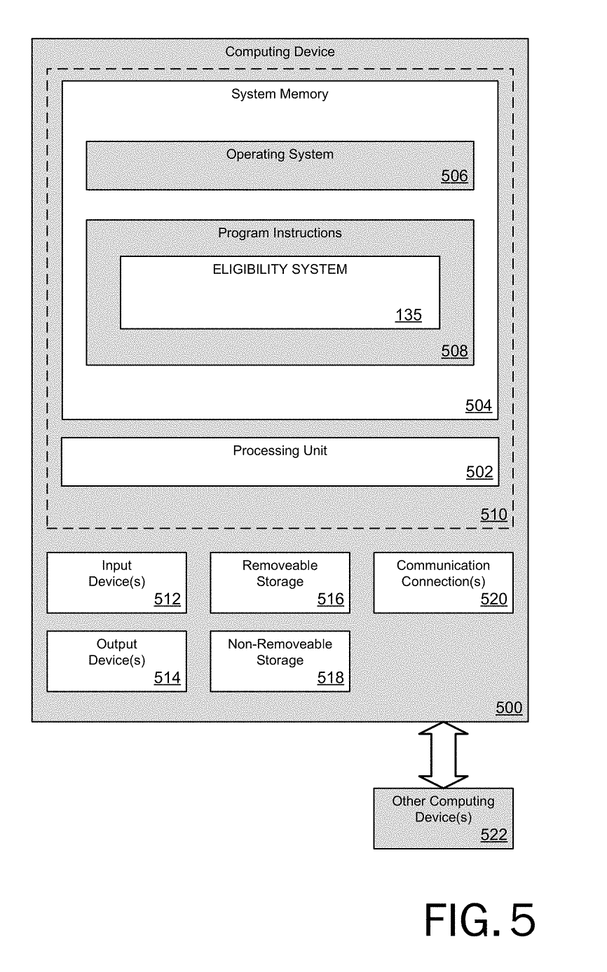

Each of the requestor devices 310, assistance provider systems 320, qualification system 135, and the assistance plan database 120 are illustrative of a service or computing device, the elements of which are discussed in greater detail in regard to FIG. 5. The various devices are in communication with one another via various networks, including intranets and the Internet, to send and receive transactions related to services provided by the clients using the requestor devices 310 and the pre-arranged assistance providers who are obliged to assist in providing (at least partial) settlement for those services for a given consumer.

To reduce the bandwidth needed to receive assistance for a given service from a pre-arrange assistance provider, the qualification system 135 is configured to receive and normalize qualification requests 130 from the requestor devices 310 before completing the transaction with the assistance provider system 320 on behalf of the requestor 150. Because communicating parties, even when conforming to an industry-defined standard, may often include ambiguously coded values in their communications, the qualification system 135 determines whether an assistance option exists that may be coded differently by the two parties to thereby reduce the number of communications needed between the parties.

The plans used for providing the consumer with assistance are collected from the assistance provider systems 320 and are stored locally to the qualification system 135 in the assistance plan database 120. The plans lay out the various assistance options offered by the pre-arranged assistance provider and the service type codes that the assistance options are related to. Candidate options for the assistance are discovered based on the data received in the qualification request 130 and the synonymous codes identified by the qualification system 135. The candidate options an analyzed according to various rules or courses to quickly and accurately identify a preferred match for a code, which is presented to a user of a requestor device 310 for further analysis.

The user is enabled to update the service code to match the other party's interpretation or override the determination to use the original or a different code. The transaction is then handled according to the user's code selection and forwarded to the appropriate assistance provider's system 320.

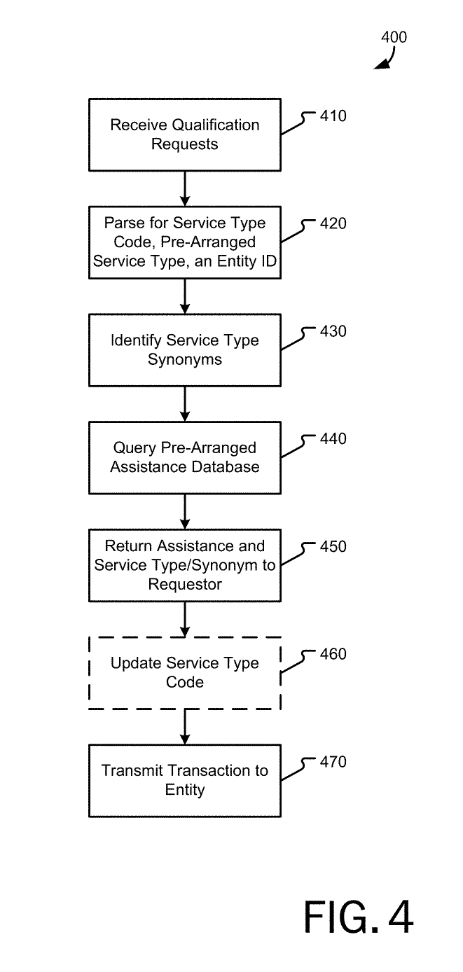

FIG. 4 is a high level flowchart of one example of a method 400 for providing qualification determinations. Method 400 begins with OPERATION 410, where qualification requests 130 are received from requestor devices 310 by a qualification system 135. In various aspects, the qualification requests 130 are 271-transactions sent from service providers to determine what pre-arranged assistance is available for a consumer registered for pre-arranged assistance with an entity acting as a pre-arranged assistance provider (e.g., a second-party obligator, an insurance provider). As discussed above, transactions often include coded values for services that may be ambiguously interpreted; a given service may be validly encoded in more than one way by different entities. Therefore, to reduce the amount of communications between the requestor devices 310 and the entity systems 320 that will eventually handle the transaction, the qualification system 135 is configured to reformat data present in the qualification requests 130 to provide the preferred assistance option, thus reducing the bandwidth and processing resources to provide accurate estimates to consumers and qualification transactions that will be accepted by the entities.

For each qualification request 130 received at OPERATION 410, method 400 proceeds to OPERATION 420, where the qualification request 130 is parsed for a service type code, a requested type of pre-arranged assistance, and an identifier for an entity providing the pre-arranged assistance. In various standards these data are parsed via tags in the qualification request 130 or by their position in the qualification request 130. For example, in a comma separated value file, an entry appearing immediately before the nth comma will be parsed as different from the entry appearing immediately before the (n+1)th comma. In another example, an entry appearing between the tags of “<servicetypecode>” and </servicetypecode>” will be parsed as being related to a service type code, whereas an entry appearing between the tags of “<EntityID>” and </EntityID>” will be parsed as being related to an entity identifier. As will be appreciated, the forgoing are given as non-limiting examples.

After parsing the qualification request 130, service type synonyms related to the parsed service type code are identified at OPERATION 430. As a given service may be coded properly under several different service type codes, depending on how the service is interpreted, a given service type code may include none, one, or several synonymous service type codes. For example, services related to emergency care may be encoded in the X12 standard as “86—emergency services”, but also as “IC—intensive care”, “UC—urgent care”, and specific systems related to the emergency (e.g., “B1—burn care” for burn-related emergencies).

Proceeding to OPERATION 440, the pre-arranged assistance database 120 is queried with the service type code and the synonym service types to determine whether pre-arranged assistance of the requested type of pre-arranged assistance is provided by the entity associated with the entity identifier for the consumer for whom the qualification request 130 was submitted. In aspects where multiple matches for the service type codes and the synonym service types are returned as being provided by the entity, a waterfall process is employed to identify a single match as the “best” match based on preferences set by the client. In other aspects where multiple matches are returned, an amount for pre-arranged assistance found for each match is determined, and the pre-arranged assistance with the highest amount is selected as the “best” match.

At OPERATION 450 the amount of assistance and the service type code (whether submitted or a synonym) related to the assistance selected as the “best” match are returned to the requestor 150. In various aspects, a user interface is populated with an alert to indicate to a user whether the service type code submitted in the qualification request 130 is the match or whether a different service type code (i.e., one of the synonyms) is the match. The client user may override the match of a synonym, accept the synonym for replacing the originally submitted service type code, or submit a new service type code (either for processing the transaction or for a new qualification request 130).

Optionally at OPERATION 460, the data received in the qualification request 130 are updated for handling the transaction, according to the client user's selection in OPERATION 450. For example, when the client user accepts the synonym service type code selected as the match, it will be used in any further transactions related to the qualification request 130 and the service type code is updated accordingly. In aspects where the originally submitted service type code is selected as the match or chosen by the client user to override a different code as the match, optional OPERATION 460 is omitted.

Method 400 proceeds to OPERATION 470 to transmit the transaction from the requestor to the entity according to the selection made by the requestor regarding the service type code. Method 400 then concludes, but may repeat when the next qualification request 130 is received.

FIG. 5 is a block diagram illustrating physical components of an example computing device with which aspects may be practiced. The computing device 500 may include at least one processing unit 502 and a system memory 504. The system memory 504 may comprise, but is not limited to, volatile (e.g. random access memory (RAM)), non-volatile (e.g. read-only memory (ROM)), flash memory, or any combination thereof. System memory 504 may include operating system 506, one or more program instructions 508, and may include sufficient computer-executable instructions for a qualification system 135, which when executed, perform functionalities as described herein. Operating system 506, for example, may be suitable for controlling the operation of computing device 500. Furthermore, aspects may be practiced in conjunction with a graphics library, other operating systems, or any other application program and is not limited to any particular application or system. This basic configuration is illustrated by those components within a dashed line 510. Computing device 500 may also include one or more input device(s) 512 (keyboard, mouse, pen, touch input device, etc.) and one or more output device(s) 514 (e.g., display, speakers, a printer, etc.).

The computing device 500 may also include additional data storage devices (removable or non-removable) such as, for example, magnetic disks, optical disks, or tape. Such additional storage is illustrated by a removable storage 516 and a non-removable storage 518. Computing device 500 may also contain a communication connection 520 that may allow computing device 500 to communicate with other computing devices 522, such as over a network in a distributed computing environment, for example, an intranet or the Internet. Communication connection 520 is one example of a communication medium, via which computer-readable transmission media (i.e., signals) may be propagated.

Programming modules, may include routines, programs, components, data structures, and other types of structures that may perform particular tasks or that may implement particular abstract data types. Moreover, aspects may be practiced with other computer system configurations, including hand-held devices, multiprocessor systems, microprocessor-based or programmable user electronics, minicomputers, mainframe computers, and the like. Aspects may also be practiced in distributed computing environments where tasks are performed by remote processing devices that are linked through a communications network. In a distributed computing environment, programming modules may be located in both local and remote memory storage devices.

Furthermore, aspects may be practiced in an electrical circuit comprising discrete electronic elements, packaged or integrated electronic chips containing logic gates, a circuit using a microprocessor, or on a single chip containing electronic elements or microprocessors (e.g., a system-on-a-chip (SoC)). Aspects may also be practiced using other technologies capable of performing logical operations such as, for example, AND, OR, and NOT, including, but not limited to, mechanical, optical, fluidic, and quantum technologies. In addition, aspects may be practiced within a general purpose computer or in any other circuits or systems.

Aspects may be implemented as a computer process (method), a computing system, or as an article of manufacture, such as a computer program product or computer-readable storage medium. The computer program product may be a computer storage medium readable by a computer system and encoding a computer program of instructions for executing a computer process. Accordingly, hardware or software (including firmware, resident software, micro-code, etc.) may provide aspects discussed herein. Aspects may take the form of a computer program product on a computer-usable or computer-readable storage medium having computer-usable or computer-readable program code embodied in the medium for use by, or in connection with, an instruction execution system.

Although aspects have been described as being associated with data stored in memory and other storage mediums, data can also be stored on or read from other types of computer-readable media, such as secondary storage devices, like hard disks, floppy disks, or a CD-ROM, or other forms of RAM or ROM. The term computer-readable storage medium refers only to devices and articles of manufacture that store data or computer-executable instructions readable by a computing device. The term computer-readable storage media do not include computer-readable transmission media.

Aspects of the present invention may be used in various distributed computing environments where tasks are performed by remote processing devices that are linked through a communications network.

Aspects of the invention may be implemented via local and remote computing and data storage systems. Such memory storage and processing units may be implemented in a computing device. Any suitable combination of hardware, software, or firmware may be used to implement the memory storage and processing unit. For example, the memory storage and processing unit may be implemented with computing device 500 or any other computing devices 522, in combination with computing device 500, wherein functionality may be brought together over a network in a distributed computing environment, for example, an intranet or the Internet, to perform the functions as described herein. The systems, devices, and processors described herein are provided as examples; however, other systems, devices, and processors may comprise the aforementioned memory storage and processing unit, consistent with the described aspects.

The description and illustration of one or more aspects provided in this application are intended to provide a thorough and complete disclosure the full scope of the subject matter to those skilled in the art and are not intended to limit or restrict the scope of the invention as claimed in any way. The aspects, examples, and details provided in this application are considered sufficient to convey possession and enable those skilled in the art to practice the best mode of the claimed invention. Descriptions of structures, resources, operations, and acts considered well-known to those skilled in the art may be brief or omitted to avoid obscuring lesser known or unique aspects of the subject matter of this application. The claimed invention should not be construed as being limited to any embodiment, aspects, example, or detail provided in this application unless expressly stated herein. Regardless of whether shown or described collectively or separately, the various features (both structural and methodological) are intended to be selectively included or omitted to produce an embodiment with a particular set of features. Further, any or all of the functions and acts shown or described may be performed in any order or concurrently. Having been provided with the description and illustration of the present application, one skilled in the art may envision variations, modifications, and alternate embodiments falling within the spirit of the broader aspects of the general inventive concept provided in this application that do not depart from the broader scope of the present disclosure.

We claim:

1. A method for selection of pre-arranged assistance options from a qualification transaction, comprising:
receiving qualification requests from requestors;
for each qualification request received:
parsing the qualification request for a service type code, an assistance type, and an entity identifier;
identifying service type synonyms related to the service type code;
querying an assistance plan database with the assistance type and the entity identifier to determine an assistance option of the assistance type associated with the service type code or the service type synonyms that an entity associated with the entity identifier provides; and
returning the assistance option and the service type or service type synonym associated with the assistance option to a given requestor from whom the qualification request was received.

2. The method of claim 1, further comprising:
in response to determining that multiple assistance options are provided by the entity, identifying a hierarchical list of attributes for assistance options, wherein the hierarchical list orders attributes from most preferred assistance option to least preferred assistance option;
comparing the attributes against the multiple assistance options according to the hierarchical list to select a preferred assistance option provided by the entity; and
in response to identifying a match between the attributes and the multiple assistance options, returning the match as the assistance option.

3. The method of claim 2, wherein the attributes include a service type category, a coverage level category, a time period qualifier, and a network indicator; and
wherein comparing the attributes against the multiple assistance options according to the hierarchical list waterfalls combinations of the attributes such to identify the match.

4. The method of claim 2, wherein comparing the attributes against the multiple assistance options according to the hierarchical list further comprises:
identifying each match between the attributes and the multiple assistance options; and
selecting a given match having a highest assistance amount as the match.

5. The method of claim 2, wherein the hierarchical list of attributes is identified based on the given requestor and the entity.

6. The method of claim 1, wherein a given service type synonym is associated with the assistance option, further comprising:
receiving, from the requestor, confirmation of the given service type synonym;
updating the qualification transaction according to the given service type synonym; and
transmitting the qualification transaction to the entity.

7. The method of claim 1, wherein a given service type synonym is associated with the assistance option, further comprising:
receiving, from the requestor, an overriding service type code for the service type synonym;
updating the qualification transaction according to the overriding service type code; and
transmitting the qualification transaction to the entity.

8. The method of claim 7, wherein the overriding service type code is the service type code.

9. A system for selection of pre-arranged assistance options from a qualification transaction, comprising:
a processor; and
a memory storage device including instructions that when executed by the processor enable the system to:
receive qualification requests from requestors;
for each qualification request received:
parse the qualification request for a service type code, an assistance type, and an entity identifier;
identify service type synonyms related to the service type code;
query an assistance plan database with the assistance type and the entity identifier to identify assistance options of the assistance type associated with the service type code or the service type synonyms that an entity associated with the entity identifier provides;
identify a given assistance option of the assistance options as a best assistance option, including:
identify a hierarchical list of attributes of the assistance options, wherein the hierarchical list organizes the attributes in cascading sets associated with assistance options from most preferred to least preferred;
compare the cascading sets against the assistance options according to the hierarchical list; and
in response to identifying a first match between the cascading sets and the assistance options, return the match as the best assistance option; and
return the best assistance option and the service type or service type synonym associated with the best assistance option to a given requestor from whom the qualification request was received.

10. The system of claim 9, wherein the attributes include a service type category, a coverage level category, a time period qualifier, and a network indicator; and
wherein the cascading sets reselects the network indicator before the time period qualifier, reselects the time period before the coverage level category, and reselects the coverage level category before the service type category

11. The system of claim 9, wherein the hierarchical list of attributes is identified based on the given requestor and the entity.

12. The system of claim 9, wherein a given service type synonym is associated with the best assistance option, further comprising:
receiving, from the requestor, confirmation of the given service type synonym;
updating the qualification transaction according to the given service type synonym; and
transmitting the qualification transaction to the entity.

13. The system of claim 9, wherein a given service type synonym is associated with the best assistance option, further comprising:
receiving, from the requestor, an overriding service type code for the given service type synonym;
updating the qualification transaction according to the overriding service type code; and
transmitting the qualification transaction to the entity.

14. The system of claim 13, wherein the overriding service type code is the service type code.

15. A computer readable storage device including processor executable instructions for selection of pre-arranged assistance options from a qualification transaction, comprising:
receiving qualification requests from requestors;
for each qualification request received:
parsing the qualification request for a service type code, an assistance type, and an entity identifier;
identifying service type synonyms related to the service type code;
querying an assistance plan database with the assistance type and the entity identifier to identify assistance options of the assistance type associated with the service type code or the service type synonyms that an entity associated with the entity identifier provides;
identifying a given assistance option of the assistance options as a best assistance option, including:
identifying a hierarchical list of attributes of the assistance options, wherein the hierarchical list organizes the attributes in cascading sets associated with assistance options from most preferred to least preferred;
comparing the cascading sets against the assistance options according to the hierarchical list; and
in response to identifying a first match between the cascading sets and the assistance options, returning the match as the best assistance option; and
returning the best assistance option and the service type or service type synonym associated with the best assistance option to a given requestor from whom the qualification request was received.

16. The computer readable storage device of claim 15, wherein the attributes include a service type category, a coverage level category, a time period qualifier, and a network indicator; and
wherein the cascading sets reselects the network indicator before the time period qualifier, reselects the time period before the coverage level category, and reselects the coverage level category before the service type category.

17. The computer readable storage device of claim 15, wherein the hierarchical list of attributes is identified based on the given requestor and the entity.

18. The computer readable storage device of claim 15, wherein a given service type synonym is associated with the best assistance option, further comprising:
receiving, from the requestor, confirmation of the given service type synonym;
updating the qualification transaction according to the given service type synonym; and
transmitting the qualification transaction to the entity.

19. The computer readable storage device of claim 15, wherein a given service type synonym is associated with the best assistance option, further comprising:
receiving, from the requestor, an overriding service type code for the given service type synonym;
updating the qualification transaction according to the overriding service type code; and
transmitting the qualification transaction to the entity.

20. The computer readable storage device of claim 19, wherein the overriding service type code is the service type code.
